(19) United States
(12) Patent Application Publication
(10) Pub. No.: US 2022/0204807 A1
(43) Pub. Date: Jun. 30, 2022

(54) TWO-COMPONENT POLYURETHANE ELASTOMER COATING FOR CORROSION AND WEATHERING PROTECTION

(71) Applicant: Construction Research & Technology GmbH, Trostberg (DE)

(72) Inventors: Christian BRUCHERTSEIFER, Oldenburg (DE); Klaus BUCK, Mannheim (DE); Szilard CSIHONY, Ludwigshafen (DE); Burkhard WALTHER, Oldenburg (DE); Roland NOWICKI, Mannheim (DE)

(21) Appl. No.: 17/609,116

(22) PCT Filed: May 5, 2020
(86) PCT No.: PCT/EP2020/062445

§ 371 Date: Nov. 5, 2021

(30) Foreign Application Priority Data
May 10, 2019 (EP) 19173953.1

(51) Int. Cl. C09D 175/04; C08F 110/10; C08G 18/62; C08G 18/72; C09D 5/08

(52) U.S. Cl. CPC C09D 175/04; C08F 110/10; C08G 18/6204; C08G 2150/90; C09D 5/08; C08F 2810/40; C08G 18/72

(57) ABSTRACT

The present invention relates to a two-component composition suitable for providing a coating preparation from which a cured layer can be obtained in order to protect the surface of materials against the detrimental impact of weathering and/or corrosion. The two-component composition comprises a first component C1 comprising (a) a polyolefin having a polymer backbone consisting of (a-i) repeating units derived from an olefinically unsaturated monomer having 4 carbon atoms and, optionally, (a-ii) a hydrocarbon group L having 5-20 carbon atoms in a non-terminal position of said polymer backbone, wherein said polymer backbone has functional groups selected from hydroxyl groups and amine groups at its chain ends; and (C2) a second component comprising a preparation comprising (b1) a polyisocyanate having 2 or more isocyanate groups and/or (b2) a reaction product having isocyanate groups obtained by reacting said polyisocyanate having 2 or more isocyanate groups (b1) and (b2a) a polyolefin having a polymer backbone consisting of (b2a-i) repeating units derived from an olefinically unsaturated monomer having 4 carbon atoms and, optionally, (b2a-ii) a hydrocarbon group having 5-20 carbon atoms in a non-terminal position of said polymer backbone, wherein said polymer chain has functional groups selected from hydroxyl groups and amine groups at its chain ends.

### TECHNICAL FIELD

The present invention relates to the technical field of protection against weathering and corrosion. More specifically, it relates to a coating composition suitable for preventing the deterioration of a substrate as a result of weathering and corrosion, to a two-component composition suitable for preparing said coating composition and to a substrate being at least partially coated with the coating composition. Furthermore, the present invention relates to a method of preparing a substrate being at least partially coated with the composition.

### BACKGROUND OF THE INVENTION

Corrosion is a natural process, which converts a refined metal to a more chemically-stable form, such as its oxide, hydroxide, or sulfide by electrochemical oxidation of metal in reaction with an oxidant such as oxygen or sulfates. It is the gradual destruction of materials (usually metals) by chemical and/or electrochemical reaction with their environment. Rusting, the formation of iron oxides, is a well-known example of electrochemical corrosion. Many structural alloys corrode merely from exposure to moisture in air, but the process can be strongly affected by exposure to certain substances. Corrosion can be concentrated locally to form a pit or crack, or it can extend across a wide area more or less uniformly corroding the surface. Because corrosion is a diffusion-controlled process, it occurs on exposed surfaces. As corrosion usually involves the conversion of elemental metal (i.e. metal in oxidation state 0) to ions (i.e. metal in oxidation state >0, such as +1, +2, +3 etc.) and metal ions are at least partially mobilized by the absorption of water molecules (also referred to as “hydration”), water or humidity is usually involved in corrosion and, in many or most cases, the exposure to water or humidity is essential for corrosion to occur.

Corrosion usually is the result of the impact of weathering on the surface of a substrate material. However, exposure to weathering does not affect the surface of metals, but of virtually any material. As exemplary materials commonly used in a vast array of applications in which they are exposed to conditions that would eventually result in a deterioration of the unprotected material, glass, glass ceramic, glass mineral fiber mats; metals or alloys, such as aluminum, iron, steel and nonferrous metals, or surface-finished metals or alloys such as galvanized or chromed metals; coated or painted substrates, such as powder-coated metals or alloys or painted sheet metal; plastics, such as polyvinyl chloride (rigid and flexible PVC), acrylonitrile-butadiene-styrene copolymers (ABS), polycarbonate (PC), polyamide (PA), poly(methyl methacrylate) (PMMA), polyester, epoxy resins, especially epoxy-based thermosets, polyurethanes (PUR), polyoxymethylene (POM), polyolefins (PO), polyethylene (PE) or polypropylene (PP), polystyrene (PS), ethylene/propylene copolymers (EPM) or ethylene/propylene/diene terpolymers (EPDM), where the plastics may optionally have been surface-treated by means of plasma, corona or flames; fiber-reinforced plastics, such as carbon fiber-reinforced plastics (CFP), glass fiber-reinforced plastics (GFP) or sheet molding compounds (SMC); wood, wood-based materials bonded with resins, for example phenolic, melamine or epoxy resins, resin-textile composites or further polymer composites; or concrete, mortar, brick, gypsum or natural stone such as granite, limestone, sandstone or marble can be named.

In order to ensure the long-term integrity and durability of structures of the aforementioned materials, for instance metal structures such as construction units that have to bear heavy loads, it is therefore necessary to protect the surfaces of these metal structures against weathering and/or corrosion. The heavier the loads to be borne by such structures and the heavier the weathering conditions and the more corrosive the environment of the structures, the more important is efficient protection against the impact of weathering and/or corrosion. For instance, in offshore wind farms any metal structure is exposed to a highly corrosive environment such as saline sea air or saline sea water or both. At the same time, the metal structures of the pillars of wind turbines located in offshore wind farms have to bear significant loads as a result of wind pressure. Therefore, the metal structures in pillars of wind turbines in offshore wind farms excellently illustrate the need for efficient corrosion protection.

Protection against the impact of weathering and/or corrosion can be accomplished by applying a protective coating to the surface of a structure to be protected in order to prevent exposure of said surface to the adverse environment. Polymer coatings have been commonly employed for this purpose. Polymers suitable for being used as such coatings have to comply with requirements such as
(i) being hydrophobic in order to prevent water from migrating into the polymer coating such that contact of the coated surface with water (being a chemical compound often essential for corrosion to occur) is prevented,
(ii) being capable of adhering to the surfaces of the material to be protected in order to avoid undesired premature separation from the surface,
(iii) having mechanical properties such as a sufficiently high impact strength over a broad range of temperature such as from −70° C. to +150° C. in order to be suitable for being used in an environment such as polar regions and, in particular in the case of metal structures, in order to endure temperatures occurring when processing such as soldering or welding is carried out in the vicinity of the coating,
(iv) being chemically stable in the environment of the surface to be protected which commonly implies properties such as oxidation resistance and weathering resistance.

It is difficult to fully meet each of these requirements at the same time, i.e. it usually necessary to find a balance of properties. For instance, it can be difficult to achieve good adhesion of the polymer to a metal surface and, at the same time, high hydrophobicity of the polymer. The reason is that good adherence to a metal surface usually implies the presence of some polar groups in the polymer which interact (by means of dipole-dipole forces or ion-dipole forces) with an ionic layer present on the metal surface as a result of passivation.

As coating materials for corrosion prevention, polymers such as polyethylene, polyurethane elastomers have been investigated as described by F. Gouranlou in Asian Journal of Chemistry, vol. 19, no. 2 (2007), pages 1645-1647 (“Anti-Corrosive Coating Prepared from Hydroxy Terminated Poylbutadiene”) and K. Suzuki et al. at the 7^{th} International Conference on the Internal and External Protection of Pipes, London, England (21-23 Sep. 1987), Paper C4 (“Polyurethane Elastomer Coated Steel Pipe”).

JP 2017-165024 A discloses a multi-layered polyurethane coated steel material which has high corrosion resistance and in which exposure of a steel surface is prevented even in low-temperature environment, wherein the polyurethane resin layer is formed of two layers of a soft polyurethane resin layer or a hard polyurethane resin layer. The soft polyurethane resin layer has an elastomer backbone based on a reaction product of polybutadiene polyol and methylene diphenyldiisocyanate (MDI) or toluene diisocyanate (TDI).

JP 2006-043576 A discloses a method of protecting an underwater structure, which can prevent the attachment of underwater creatures particularly on the underwater structure surface which coating comprises a polyurethane elastomer coating obtained by reacting a polybutadiene polyol and an aliphatic diisocyanate.

JP 2001-323431 A discloses a polyurethane coating for protecting steel against corrosion, wherein the polyurethane coating is based on polybutadiene polyol and methylene diphenyl diisocyanate.

JP 4427165 B2 discloses a high-strength polyurethane coating having excellent impact resistance and peeling resistance for preventing corrosion of steel products. The polyurethane coating is prepared from a polybutadiene polyol and methylene diphenyldiisocyanate (MDI).

JPS 62263263 A discloses a liquid diene rubber containing a functional group from which a cured coating film can be formed on the surface of an object to be protected against corrosion in a marine environment. Polybutadiene having terminal functional groups such as a hydroxyl group or a carboxyl group are mentioned as exemplary liquid dienes for forming said cured coating film.

US 2013/040128 A1 discloses a chemical resistant polyurea composition that may retain physical integrity even when continuously or semi-continuously exposed to a corrosive environment comprising alkalis or acids. The pulyurea composition is obtained by reacting a polyalkadiene polyol with a polyisocyanate at a temperature and for a time sufficient to result in a polyurea prepolymer containing less than 5 wt. % NCO; admixing the polyurea prepolymer containing less than 5 wt. % NCO with a polyfunctional amine curing agent and at least one of a solvent, a UV absorber, an antioxidant, and a colorant to form a curable composition, wherein the polyurea prepolymer and the polyfunctional amine are admixed at a stoichiometric ratio, based on equivalents, in the range from about 1.03:1 to 1.08:1; and curing the curable composition to form the chemical resistant polyurea composition.

JPS 62218410 A discloses a composition comprising a hydrogenated derivative of a liquid diene polymer having a hydroxyl group and an epoxy group and a polyisocyanate compound which gives a cured article having excellent weathering resistance.

EP 1 279 687 A2 discloses composition comprising (A) non-branched polybutadiene having terminal hydroxyl functionality less than 2 per molecule by average; and (B) branched polybutadiene having terminal hydroxyl functionality more than 2 per molecule by average; the weight ratio of (A) to (B) being about 99:1 to 1:99. These compositions are reacted with organic polyisocyanates to form prepolymers which are cured by reaction with a chain extender such as a diol to produce cured resins.

WO 2017/0170089 A discloses a two-component polyurethane composition, comprising a first component, which comprises at least one polybutadiene polyol having an average OH functionality in the range of 2.1 to 4, a second component, which comprises at least one polyisocyanate and optionally at least one isocyanate-terminated polyurethane prepolymer, and a hydrophobic diol. The cured composition has good adhesion properties on substrates having low surface energy and by high strength over a broad range of temperature and is therefore particularly suitable as a structural adhesive.

WO 2011/022583 A1 discloses polyisobutylene-based polymers which comprise a polyisobutylene segment having two or more reactive groups that is crosslinked by reacting with an agent having two or more isocyanate groups. The crosslinked polymer can used in a medical device.

WO 2017/132106 A1 discloses a polyisobutylene-based polyurethane-urea composition obtained by preparing a prepolymer of hydroxyl-terminated polyisobutylene and a diisocyanate which is subsequently reacted with a chain extender.

WO 2017/1966913 A1 discloses a polyisobutylene polymer obtained by reacting a polyisobutylene diol, a diisocyanate, and at least one crosslinking compound residue selected from the group consisting of a residue of a sorbitan ester and a residue of a branched polypropylene oxide polyol, wherein as the first step a prepolymer is formed from said polyisobutylene diol and said diisocyanate.

Despite these efforts, there is the desire to have available polymer compositions that are suitable as protective coatings of substrate surfaces such as metal surfaces and combine the abovementioned properties in a balanced manner in order to protect the substrate surfaces against deterioration as a result of weathering and corrosion. The present invention has been completed in response to this desire.

### BRIEF DESCRIPTION OF THE INVENTION

In a first aspect, the present invention is directed to a two-component composition comprising a first component C1 comprising (a) a polyolefin having a polymer backbone consisting of (a-i) repeating units derived from an olefinically unsaturated monomer having 4 carbon atoms and, optionally, (a-ii) a hydrocarbon group L having 5-20 carbon atoms in a non-terminal position of said polymer backbone, wherein said polymer backbone has functional groups selected from hydroxyl groups and amine groups at its chain ends; and a second component comprising a preparation comprising (b1) a polyisocyanate having 2 or more isocyanate groups and/or (b2) a reaction product having isocyanate groups obtained by reacting said polyisocyanate having 2 or more isocyanate groups (b1) and (b2a) a polyolefin having a polymer backbone consisting of (b2a-i) repeating units derived from an olefinically unsaturated monomer having 4 carbon atoms and, optionally, (b2a-ii) a hydrocarbon group having 5-20 carbon atoms in a non-terminal position of said polymer backbone, wherein said polymer chain has functional groups selected from hydroxyl groups and amine groups at its chain ends.

In a second aspect, the present invention is directed to a method of preparing a coating layer from the two-component composition according to the first aspect of the invention, which method comprises the steps of (i) mixing the first component C1 and the second component C2 of the two-component composition according to the first aspect of the invention, (ii) applying the mixed components C1 and C2 to a substrate such that a layer is formed and (iii) allowing the mixed components C1 and C2 to cure.

In a third aspect, the present invention is directed to a cured composition obtainable by (i) mixing the first component C1 and the second component C2 of the two-component composition according to the first aspect of the invention and (ii) allowing the mixed components C1 and C2 to cure. from the two-component composition.

In a fourth aspect, the present invention is directed to a coated article comprising a substrate and a layer of the cured composition according to the third aspect of the present invention.

According to the fifth aspect of the invention, the present invention is directed to a coating preparation obtainable by mixing the first component C1 and the second component C2 of the two-component composition according to the first aspect.

In a sixth aspect, the present invention is directed to the use of the coating preparation according to the fifth aspect for coating an article.

In a seventh aspect, the present invention is directed to a novel polyolefin which is particularly useful in the two-component composition according to the first aspect of the present invention and, likewise, in the second to fifth aspect of the present invention.

### DETAILED DESCRIPTION OF THE INVENTION

According to the first aspect of the invention, there is provided a two-component composition as defined in the following.

(1.1) Two-component composition comprising, in a spatially separated arrangement,
(C1) a first component comprising (a) a polyolefin having a polymer backbone consisting of (a-i) repeating units derived from an olefinically unsaturated monomer having 4 carbon atoms and, optionally, (a-ii) a hydrocarbon group L having 5-20 carbon atoms in a non-terminal position of said polymer backbone, wherein said polymer backbone has functional groups selected from hydroxyl groups and amine groups at its chain ends; and
(C2) a second component comprising a preparation comprising (b1) a polyisocyanate having 2 or more isocyanate groups and/or (b2) a reaction product having isocyanate groups obtained by reacting said polyisocyanate having 2 or more isocyanate groups (b1) and (b2a) a polyolefin having a polymer backbone consisting of (b2a-i) repeating units derived from an olefinically unsaturated monomer having 4 carbon atoms and, optionally, (b2a-ii) a hydrocarbon group having 5-20 carbon atoms in a non-terminal position of said polymer backbone, wherein said polymer chain has functional groups selected from hydroxyl groups and amine groups at its chain ends.

Preferred embodiments of the two-component composition according to the first aspect of the invention are described in the following.

(1.2) Two-component composition as defined under item (1.1), wherein, if said hydrocarbon group is present in the polymer backbone of polyolefin (a), the molar ratio of said repeating units (a-i) and said hydrocarbon group is in the range of 5-200.

(1.3) Two-component composition as defined under item (1.1), wherein, if said hydrocarbon group is present in the polymer backbone of polyolefin (a), the molar ratio of said repeating units (a-i) and said hydrocarbon group is in the range of 10-150.

(1.4) Two-component composition as defined under item (1.1), wherein, if said hydrocarbon group is present in the polymer backbone of polyolefin (a), the molar ratio of said repeating units (a-i) and said hydrocarbon group is in the range of 15-100.

(1.5) Two-component composition as defined under item (1.1), wherein, if said hydrocarbon group is present in the polymer backbone of polyolefin (a), the molar ratio of said repeating units (a-i) and said hydrocarbon group is in the range of 20-50.

(1.6) Two-component composition as defined under item (1.1), wherein, if said hydrocarbon group is present in the polymer backbone of polyolefin (a), the molar ratio of said repeating units (a-i) and said hydrocarbon group is in the range of 25-40.

(1.7) Two-component composition as defined under any one of items (1.1)-(1.6), wherein said olefinically unsaturated monomer having 4 carbon atoms has 1 olefinic double bond or 2 olefinic double bonds.

(1.8) Two-component composition as defined under item (1.7), wherein said olefinically unsaturated monomer having 4 carbon atoms is selected from the group consisting of butadiene, n-butene, 2-butene, isobutene and mixtures thereof.

(1.9) Two-component composition as defined under any one of items (1.1)-(1.8), wherein the functional groups of the polyolefin (a) are amine groups.

(1.10) Two-component composition as defined under any one of items (1.1)-(1.9), wherein the functional groups of the polyolefin (a) are primary amine groups NH₂.

(1.11) Two-component composition as defined under any one of items (1.1)-(1.10), wherein the functional groups of the polyolefin (a) are secondary amine groups NHR, wherein R represents a hydrocarbon group having 1 to 12 carbon atoms.

(1.12) Two-component composition as defined under item (1.11), wherein R represents a linear or branched alkyl group having 1-6 carbon atoms, preferably 1-4 carbon atoms.

(1.13) Two-component composition as defined under any one of items (1.1)-(1.8), wherein the functional groups of the polyolefin (a) are hydroxyl groups.

(1.14) Two-component composition as defined under any one of items (1.1)-(1.8) and (1.13), wherein the polyolefin (a) is a polyolefin represented by formula (I), (II), (III), (IV) or a combination of these polyolefins,

HO-cyclhexyl-[—CH₂—C(CH₃)₂]ₙ₁-Lₘ-[—C(CH₃)₂−CH₂]ₙ₂-cyclohexyl-OH (I)

HO-cyclhexyl-[—CH₂—C(CH₃)₂]ₙ₁-Lₘ-[—CH₂—C(CH₃)₂]ₙ₂-cyclohexyl-OH (II)

HO-cyclhexyl-[—C(CH₃)₂—CH₂]ₙ₁-Lₘ-[—CH₂—C(CH₃)₂]ₙ₂-cyclohexyl-OH (III)

HO-cyclhexyl-Xₙ₁-Lₘ-Xₙ₂-cyclohexyl-OH (IV)

wherein

each X independently represents a repeating unit of formula #1-[—C(CH₃)₂—CH₂]-#2 wherein #1 and #2 represent the positions at which the repeating unit forms a bond to an adjacent moiety and wherein a bond between two adjacent repeating units is formed such that positions #1 and #1, #1 and #2, #2 and #1 or #2 and #2 of the adjacent repeating units are bonded to each other,

L is a hydrocarbon group having 5 or more carbon atoms,

m is 0 or 1,

each of n1 and n2 is a numerical value of 1 or more and

n1+n2 is in the range of from 5-200, preferably 10-150, more preferably 15-100, even more preferably 20-50, most preferably 25-40.

(1.15) Two-component composition as defined under any one of items (1.1)-(1.14), wherein L is a group having 6-20 carbon atoms and comprising an aromatic moiety.

(1.16) Two-component composition as defined under item (1.15), wherein L is a group having 6-14 carbon atoms.

(1.17) Two-component composition as defined under item (1.15), wherein L is a group having 6-12 carbon atoms.

(1.18) Two-component composition as defined under item (1.15), wherein L is a group represented by the following formula,

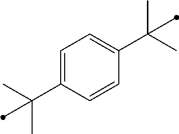

wherein the positions marked with indicate the position to which the repeating units (a-i) of the polymer backbone are attached.

(1.19) Two-component composition as defined under any one of items (1.1)-(1.18), wherein, if said hydrocarbon group is present in the polymer backbone of polyolefin (b2a), the molar ratio of said repeating units (b2a-i) and said hydrocarbon group is in the range of 5-200.

(1.20) Two-component composition as defined under any one of items (1.1)-(1.18), wherein, if said hydrocarbon group is present in the polymer backbone of polyolefin (b2a), the molar ratio of said repeating units (b2a-i) and said hydrocarbon group is in the range of 10-150.

(1.21) Two-component composition as defined under any one of items (1.1)-(1.18), wherein, if said hydrocarbon group is present in the polymer backbone of polyolefin (b2a), the molar ratio of said repeating units (b2a-i) and said hydrocarbon group is in the range of 15-100.

(1.22) Two-component composition as defined under any one of items (1.1)-(1.18), wherein, if said hydrocarbon group is present in the polymer backbone of polyolefin (b2a), the molar ratio of said repeating units (b2a-i) and said hydrocarbon group is in the range of 20-50.

(1.23) Two-component composition as defined under any one of items (1.1)-(1.18), wherein, if said hydrocarbon group is present in the polymer backbone of polyolefin (b2a), the molar ratio of said repeating units (b2a-i) and said hydrocarbon group is in the range of 25-40.

(1.24) Two-component composition as defined under any one of items (1.1)-(1.23), wherein said olefinically unsaturated monomer having 4 carbon atoms has 1 olefinic double bond or 2 olefinic double bonds.

(1.25) Two-component composition as defined under item (1.24), wherein said olefinically unsaturated monomer having 4 carbon atoms is selected from the group consisting of butadiene, n-butene, 2-butene, isobutene and mixtures thereof.

(1.26) Two-component composition as defined under any one of items (1.1)-(1.25), wherein the functional groups of the polyolefin (b2a) are amine groups.

(1.27) Two-component composition as defined under any one of items (1.1)-(1.26), wherein the functional groups of the polyolefin (b2a) are primary amine groups —NH₂.

(1.28) Two-component composition as defined under any one of items (1.1)-(1.26), wherein the functional groups of the polyolefin (b2a) are secondary amine groups —NHR, wherein R represents a hydrocarbon group having 1 to 12 carbon atoms.

(1.29) Two-component composition as defined under item (1.28), wherein R represents a linear or branched alkyl group having 1-6 carbon atoms, preferably 1-4 carbon atoms.

(1.30) Two-component composition as defined under any one of items (1.1)-(1.25), wherein the functional groups of the polyolefin (b2a) are hydroxyl groups.

(1.31) Two-component composition as defined under any one of items (1.1)-(1.25) and

(1.30), wherein the polyolefin (b2a) is a polyolefin represented by formula (I), (II), (III), (IV) or a combination of these polyolefins,

HO-cyclhexyl-[—CH₂—C(CH₃)₂]ₙ₁-Lₘ-[—C(CH₃)₂−CH₂]ₙ₂-cyclohexyl-OH (I)

HO-cyclhexyl-[—CH₂—C(CH₃)₂]ₙ₁-Lₘ-[—CH₂—C(CH₃)₂]ₙ₂-cyclohexyl-OH (II)

HO-cyclhexyl-[—C(CH₃)₂—CH₂]ₙ₁-Lₘ-[—CH₂—C(CH₃)₂]ₙ₂-cyclohexyl-OH (III)

HO-cyclhexyl-Xₙ₁-Lₘ-Xₙ₂-cyclohexyl-OH (IV)

wherein

each X independently represents a repeating unit of formula #1-[—C(CH₃)₂—CH₂]-#2 wherein #1 and #2 represent the positions at which the repeating unit forms a bond to an adjacent moiety and wherein a bond between two adjacent repeating units is formed such that positions #1 and #1, #1 and #2, #2 and #1 or #2 and #2 of the adjacent repeating units are bonded to each other,

L is a hydrocarbon group having 5 or more carbon atoms,

m is 0 or 1,

each of n1 and n2 is a numerical value of 1 or more and

n1+n2 is in the range of from 5-200, preferably 10-150, more preferably 15-100, even more preferably 20-50, most preferably 25-40.

(1.32) Two-component composition as defined under any one of items (1.1)-(1.31), wherein L is a group having 6-20 carbon atoms and comprising an aromatic moiety.

(1.33) Two-component composition as defined under item (1.32), wherein L is a group having 6-14 carbon atoms.

(1.34) Two-component composition as defined under item (1.32), wherein L is a group having 6-12 carbon atoms.

(1.35) Two-component composition as defined under item (1.32), wherein L is a group represented by the following formula,

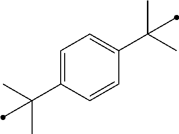

wherein the positions marked with indicate the position to which the repeating units (b2a-i) of the polymer backbone are attached.

(1.36) Two-component composition as defined under any one of items (1.1)-(1.25) and (1.30), wherein the polyolefin (a) and/or polyolefin (b2a) is represented by the following formula,

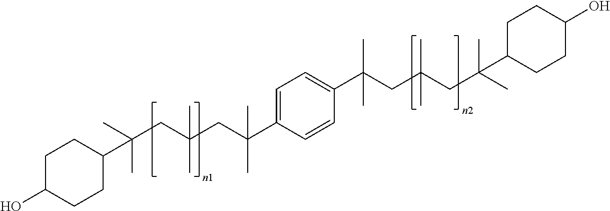

wherein each of n1 and n2 is a numerical value of 1 or more and

n1+n2 is in the range of from 5-200, preferably 10-150, more preferably 15-100, even more preferably 20-50, most preferably 25-40.

(1.37) Two-component composition as defined under any one of items (1.1)-(1.36), wherein said polyolefin (b2a) is the same as polyolefin (a).

(1.38) Two-component composition as defined under any one of items (1.1)-(1.36), wherein said a polyolefin (b2a) is different from polyolefin (a).

(1.39) Two-component composition as defined under any one of items (1.1)-(1.38), wherein the average number of functional groups present in said polyolefin (a) and/or said polyolefin (b2a) is in the range of from 1.5-2.5, preferably 1.8-2.2, more preferably 1.9-2.1.

(1.40) Two-component composition as defined under any one of items (1.1)-(1.39), wherein the molecular weight of the polyolefin (a) and/or said polyolefin (b2a) is in the range of from 200-10000 g/mol.

(1.41) Two-component composition as defined under any one of items (1.1)-(1.39), wherein the molecular weight of the polyolefin (a) and/or said polyolefin (b2a) is in the range of from 500-5000 g/mol.

(1.42) Two-component composition as defined under any one of items (1.1)-(1.39), wherein the molecular weight of the polyolefin (a) and/or said polyolefin (b2a) is in the range of from 1000-2500 g/mol.

(1.43) Two-component composition as defined under any one of items (1.1)-(1.42), wherein the component (C1) furthermore comprises a reactive diluent, which reactive diluent contains at least one functional group per molecule that can be reacted with an isocyanate group or can be converted in situ to a functional group that can be reacted with an isocyanate group.

(1.44) Two-component composition as defined under item (1.43), wherein the reactive diluent contains two functional groups per molecule that can be reacted with an isocyanate group or can be converted in situ to a functional group that can be reacted with an isocyanate group.

(1.45) Two-component composition as defined under item (1.43) or (1.44), wherein the reactive diluent is selected from the groups consisting of diols, diamines aminoalcohols, aldimines, oxazolidines, and combinations thereof, which have a molecular weight of less than 200 g/mol.

(1.46) Two-component composition as defined under any one of items (1.43)-(1.45), wherein the reactive diluent has a molecular weight of less than 150 g/mol.

(1.47) Two-component composition as defined under any one of items (1.1)-(1.46), wherein the polyisocyanate having 2 or more isocyanate groups (b1) is a diisocyanate.

(1.48) Two-component composition as defined under any one of items (1.1)-(1.47), wherein the polyisocyanate having 2 or more isocyanate groups (b1) is selected from tolylene 2,4-diisocyanate, tolylene 2,6-diisocyanate, a mixture of these isomers (TDI), diphenylmethane 4,4′-diisocyanate, diphenylmethane 2,4′-diisocyanate or diphenylmethane 2,2′-diisocyanate, a mixture of these isomers (MDI), phenylene 1,3-diisocyanate or phenylene 1,4-diisocyanate, 2,3,5,6-tetramethyl-1,4-diisocyanatobenzene, naphthalene 1,5-diisocyanate (NDI), 3,3′-dimethyl-4,4′-diisocyanatodiphenyl (TODI), dianisidine diisocyanate (DADI), tetramethylene 1,4-diisocyanate, 2-methylpentamethylene 1,5-diisocyanate, hexamethylene 1,6-diisocyanate (HDI), 2,2,4-trimethylhexamethylene 1,6-diisocyanate, 2,4,4-trimethylhexamethylene 1,6-diisocyanate, a mixture of these isomers (TMDI), decamethylene 1,10-diisocyanate, dodecamethylene 1,12-diisocyanate, cyclohexane 1,3-diisocyanate, cyclohexane 1,4-diisocyanate, 1-methyl-2,4-diisocyanatocyclohexane, 1-methyl-2,6-diisocyanatocyclohexane, a mixture of these isomers (HTDI or H6TDI), 1-isocyanato-3,3,5-trimethyl-5-isocyanatomethylcyclohexane (isophorone diisocyanate or IPDI), perhydro(diphenylmethane) 2,4′-diisocyanate, perhydro(diphenylmethane) 4,4′-diisocyanate (HMDI or H12MDI), 1,4-diisocyanato-2,2,6-trimethylcyclohexane (TMCDI), 1,3-bis(isocyanatomethyl)cyclohexane, 1,4-bis(isocyanatomethyl)cyclohexane, m-xylylene diisocyanate (m-XDI), p-xylylene diisocyanate (p-XDI), m-tetramethylxylylene 1,3-diisocyanate, m-tetramethylxylylene 1,4-diisocyanate, (m-TMXDI), p-tetramethylxylylene 1,3-diisocyanate, p-tetramethylxylylene 1,4-diisocyanate (p-TMXDI), bis(1-isocyanato-1-methylethyl)naphthalene and mixtures thereof.

(1.49) Two-component composition as defined under any one of items (1.1)-(1.47), wherein the polyisocyanate having 2 or more isocyanate groups (b1) is selected from 1-isocyanato-3,3,5-trimethyl-5-isocyanatomethylcyclohexane (isophorone diisocyanate or IPDI), diphenylmethane 4,4′-diisocyanate, diphenylmethane 2,4′-diisocyanate or diphenylmethane 2,2′-diisocyanate, a mixture of these isomers (MDI), tolylene 2,4-diisocyanate, tolylene 2,6-diisocyanate, a mixture of these isomers (TDI), perhydro(diphenylmethane) 2,4′-diisocyanate, perhydro(diphenylmethane) 4,4′-diisocyanate (HMDI or H12MDI), and mixtures thereof.

(1.50) Two-component composition as defined under any one of items (1.1)-(1.47), wherein the diisocyanate (b1) is 1-isocyanato-3,3,5-trimethyl-5-isocyanatomethylcyclohexane (isophorone diisocyanate or IPDI).

(1.51) Two-component composition as defined under any one of items (1.1)-(1.47), wherein the diisocyanate (b1) is selected from diphenylmethane 4,4′-diisocyanate, diphenylmethane 2,4′-diisocyanate or diphenylmethane 2,2′-diisocyanate, a mixture of these isomers (MDI).

(1.52) Two-component composition as defined under any one of items (1.1)-(1.51), wherein the preparation (b) is obtainable by mixing said polyisocyanate having 2 or more isocyanate groups (b1) and said polyolefin (b2a) under conditions at which a reaction between the functional groups of said polyolefin (b2a) and said polyisocyanate having 2 or more isocyanate groups (b1) occurs.

(1.53) Two-component composition as defined under any one of items (1.1)-(1.52), wherein the preparation (b) is obtainable by mixing said polyisocyanate having 2 or more isocyanate groups (b1), said polyolefin (b2a) and a catalyst, which catalyzes the reaction of the functional groups of said polyolefin (b2a) and said polyisocyanate having 2 or more isocyanate groups, under conditions at which a reaction between the functional groups of said polyolefin (b2a) and said monomeric diisocyanate (b1) occurs.

(1.54) Two-component composition as defined under any one of items (1.1)-(1.53), wherein said catalyst is selected from the group consisting of tertiary amines, amidines, guanidines, metal salts of aliphatic or alicyclic monocarboxylic acids having from about 6 to 20 carbon atoms, bismuth(III) compounds, zinc(II) compounds, tin(II) compounds, mercury(II) compounds and zirconium(IV) compounds.

(1.55) Two-component composition as defined under any one of items (1.1)-(1.54), wherein said catalyst is selected from the group consisting of a bismuth(III) carboxylate, a Zn(II) carboxylate, a bismuth(III) 1,3-ketoacetate, a zirconium(IV) 1,3-ketoacetate, a bismuth(III) oxinate, a bismuth(III) 1,3-ketoamidate, a zirconium(IV) 1,3-ketoamidate, a zirconium(IV) diketonate, alkali metal salts of fatty acids, or a mixture thereof.

(1.56) Two-component composition as defined under any one of items (1.1)-(1.55), wherein the preparation (b) is obtainable by mixing said polyisocyanate having 2 or more isocyanate groups (b1) and said a polyolefin (b2a) in such amounts that the molar ratio of the isocyanate groups present in said polyisocyanate having 2 or more isocyanate groups (b1) and the functional groups in said polyolefin (b2a) in the range of from 2:1 to 10:1.

(1.57) Two-component composition as defined under any one of items (1.1)-(1.55), wherein the preparation (b) is obtainable by mixing said polyisocyanate having 2 or more isocyanate groups (b1) and said a polyolefin (b2a) in such amounts that the molar ratio of the isocyanate groups present in said polyisocyanate having 2 or more isocyanate groups (b1) and the functional groups in said polyolefin (b2a) in the range of from 2.5:1 to 8:1.

(1.58) Two-component composition as defined under any one of items (1.1)-(1.55), wherein the preparation (b) is obtainable by mixing said polyisocyanate having 2 or more isocyanate groups (b1) and said a polyolefin (b2a) in such amounts that the molar ratio of the isocyanate groups present in said polyisocyanate having 2 or more isocyanate groups (b1) and the functional groups in said polyolefin (b2a) is in the range of from 3:1 to 6:1.

(1.59) Two-component composition as defined under any one of items (1.1)-(1.55), wherein the preparation (b) is obtainable by mixing said polyisocyanate having 2 or more isocyanate groups (b1) and said a polyolefin (b2a) in such amounts that the molar ratio of the isocyanate groups in said polyisocyanate having 2 or more isocyanate groups (b1) and the functional groups in said polyolefin (b2a) in the range of from 3.5:1 to 5:1.

(1.60) Two-component composition as defined under any one of items (1.1)-(1.59), wherein said polyolefin (a), said preparation (b) and, if present, any reactive diluent are present in amounts such that the molar amount of the isocyanate groups present in said preparation (b) is equal to or higher than the total molar amount of functional groups present in said polyolefin (a) and said reactive diluent.

(1.61) Two-component composition as defined under any one of items (1.1)-(1.59), wherein said polyolefin (a), said preparation (b) and, if present, any reactive diluent are present in amounts such that the ratio of the molar amount of the isocyanate groups present in said preparation (b) and the molar amount of functional groups present in said polyolefin (a) and said reactive diluent is in the range of from 1:1 to 1.15:1.

(1.62) Two-component composition as defined under any one of items (1.1)-(1.59), wherein said polyolefin (a), said preparation (b) and, if present, any reactive diluent are present in amounts such that the ratio of the molar amount of the isocyanate groups present in said preparation (b) and the molar amount of functional groups present in said polyolefin (a) and said reactive diluent is in the range of from 1.01:1 to 1.12:1.

(1.63) Two-component composition as defined under any one of items (1.1)-(1.59), wherein said polyolefin (a), said preparation (b) and, if present, any reactive diluent are present in amounts such that the ratio of the molar amount of the isocyanate groups present in said preparation (b) and the molar amount of functional groups present in said polyolefin (a) and said reactive diluent is in the range of from 1.02:1 to 1.10:1.

According to the second aspect of the invention, there is provided a method of preparing a coating layer from the two-component composition according to the first aspect of the invention as defined in the following.

(2.1) Method of preparing a coating layer from the two-component composition as defined under any one of items (1.1)-(1.63) comprising the steps of (i) mixing the first component C1 and the second component C2 of the two-component composition as defined under any one of items (1.1)-(1.63), (ii) applying the mixed components C1 and C2 to a substrate such that a layer is formed and (iii) allowing the mixed components C1 and C2 to cure.

(2.2) Method of preparing a coating layer as defined under item (2.1), wherein the first component C1 and the second component C2 are mixed in amounts such that the molar amount of the isocyanate groups present in the second component C2 is equal to or higher than the total molar amount of functional groups present in the first component C1.

(2.3) Method of preparing a coating layer as defined under item (2.1), wherein the first component C1 and the second component C2 are mixed in amounts such that the ratio of the molar amount of the isocyanate groups present in the second component C2 and the molar amount of functional groups present in the first component C1 is in the range of from 1:1 to 1.15:1.

(2.4) Method of preparing a coating layer as defined under item (2.1), wherein the first component C1 and the second component C2 are mixed in amounts such that the ratio of the molar amount of the isocyanate groups present in the second component C2 and the molar amount of functional groups present in the first component C1 is in the range of from 1.01:1 to 1.12:1.

(2.5) Method of preparing a coating layer as defined under item (2.1), wherein the first component C1 and the second component C2 are mixed in amounts such that the ratio of the molar amount of the isocyanate groups present in the second component C2 and the molar amount of functional groups present in the first component C1 is in the range of from 1.02:1 to 1.10:1.

(2.6) Method of preparing a coating layer as defined under any one of items (2.1)-(2.5), wherein the cured layer obtained in step (iii) has a thickness in the range of from 0.1-5 mm.

(2.7) Method of preparing a coating layer as defined under any one of items (2.1)-(2.6), wherein the substrate is selected from glass, glass ceramic, glass mineral fiber mats; metals or alloys, such as aluminum, iron, steel and nonferrous metals, or surface-finished metals or alloys such as galvanized or chromed metals; coated or painted substrates, such as powder-coated metals or alloys or painted sheet metal; plastics, such as polyvinyl chloride (rigid and flexible PVC), acrylonitrile-butadiene-styrene copolymers (ABS), polycarbonate (PC), polyamide (PA), poly(methyl methacrylate) (PMMA), polyester, epoxy resins, especially epoxy-based thermosets, polyurethanes (PUR), polyoxymethylene (POM), polyolefins (PO), polyethylene (PE) or polypropylene (PP), polystyrene (PS), ethylene/propylene copolymers (EPM) or ethylene/propylene/diene terpolymers (EPDM), where the plastics may preferably have been surface-treated by means of plasma, corona or flames; fiber-reinforced plastics, such as carbon fiber-reinforced plastics (CFP), glass fiber-reinforced plastics (GFP) or sheet molding compounds (SMC); wood, wood-based materials bonded with resins, for example phenolic, melamine or epoxy resins, resin-textile composites or further polymer composites; or concrete, mortar, brick, gypsum or natural stone such as granite, limestone, sandstone or marble.

(2.8) Method of preparing a coating layer as defined under any one of items (2.1)-(2.6), wherein the substrate is a metal substrate.

(2.9) Method of preparing a coating layer as defined under item (2.8), wherein the metal substrate is an alloy comprising iron in an amount by weight that is higher than the amount by weight of any other chemical element.

(2.10) Method of preparing a coating layer as defined under item (2.8) or item (2.9), wherein the metal substrate is an alloy comprising carbon in an amount of 2% by weight or less.

(2.11) Method of preparing a coating layer as defined under any one of items (2.8)-(2.10), wherein the metal substrate is steel.

(2.12) Method of preparing a coating layer as defined under any one of items (2.8)-(2.11), wherein the metal substrate comprises a surface coating selected from zinc, chromated zinc and a combination of these.

(2.13) Method of preparing a coating layer as defined under any one of items (2.1)-(2.12), wherein the method furthermore comprises the step of applying a topcoat layer after step (iii).

(2.14) Method of preparing a coating layer as defined under any one of items (2.1)-(2.13), wherein the method furthermore comprises the step of applying a primer layer before step (i).

According to the third aspect of the invention, there is provided a cured composition as defined in the following.

(3.1) Cured composition obtainable by (i) mixing the first component C1 and the second component C2 of the two-component composition as defined under any one of items (1.1)-(1.63) and (ii) allowing the mixed components C1 and C2 to cure.

Preferred embodiments of the cured composition according to the third aspect of the invention are described in the following.

(3.2) Cured composition as defined under item (3.1), wherein the first component C1 and the second component C2 are mixed in amounts such that the molar amount of the isocyanate groups present in the second component C2 is equal to or higher than the total molar amount of functional groups present in the first component C1.

(3.3) Cured composition as defined under item (3.1), wherein the first component C1 and the second component C2 are mixed in amounts such that the ratio of the molar amount of the isocyanate groups present in the second component C2 and the molar amount of functional groups present in the first component C1 is in the range of from 1:1 to 1.15:1.

(3.4) Cured composition as defined under item (3.1), wherein the first component C1 and the second component C2 are mixed in amounts such that the ratio of the molar amount of the isocyanate groups present in the second component C2 and the molar amount of functional groups present in the first component C1 is in the range of from 1.01:1 to 1.12:1.

(3.5) Cured composition as defined under item (3.1), wherein the first component C1 and the second component C2 are mixed in amounts such that the ratio of the molar amount of the isocyanate groups present in the second component C2 and the molar amount of functional groups present in the first component C1 is in the range of from 1.02:1 to 1.10:1.

(3.6) Cured composition as defined under any one of items (3.1)-(3.5), wherein the cured composition is in the form of a layer having a thickness in the range of from 0.1-5 mm.

According to the fourth aspect of the invention, there is provided a coated article as defined in the following.

(4.1) Coated article comprising a substrate and a layer of the cured composition as defined under any one of items (3.1)-(3.6).

Preferred embodiments of the coated article according to the fourth aspect of the invention are described in the following.

(4.2) Coated article as defined under item (4.1), wherein the substrate is selected from glass, glass ceramic, glass mineral fiber mats; metals or alloys, such as aluminum, iron, steel and nonferrous metals, or surface-finished metals or alloys such as galvanized or chromed metals; coated or painted substrates, such as powder-coated metals or alloys or painted sheet metal; plastics, such as polyvinyl chloride (rigid and flexible PVC), acrylonitrile-butadiene-styrene copolymers (ABS), polycarbonate (PC), polyamide (PA), poly(methyl methacrylate) (PMMA), polyester, epoxy resins, especially epoxy-based thermosets, polyurethanes (PUR), polyoxymethylene (POM), polyolefins (PO), polyethylene (PE) or polypropylene (PP), polystyrene (PS), ethylene/propylene copolymers (EPM) or ethylene/propylene/diene terpolymers (EPDM), where the plastics may preferably have been surface-treated by means of plasma, corona or flames; fiber-reinforced plastics, such as carbon fiber-reinforced plastics (CFP), glass fiber-reinforced plastics (GFP) or sheet molding compounds (SMC); wood, wood-based materials bonded with resins, for example phenolic, melamine or epoxy resins, resin-textile composites or further polymer composites; or concrete, mortar, brick, gypsum or natural stone such as granite, limestone, sandstone or marble.

(4.3) Coated article as defined under item (4.1) or (4.2), wherein the substrate is a metal substrate.

(4.4) Coated article as defined under item (4.3), wherein the substrate is an alloy comprising iron in an amount by weight that is higher than the amount by weight of any other chemical element.

(4.5) Coated article as defined under item (4.3) or item (4.4), wherein the substrate is an alloy comprising carbon in an amount of 2% by weight or less.

(4.6) Coated article as defined under any one of items (4.3)-(4.5), wherein the substrate is steel.

(4.7) Coated article as defined under any one of items (4.1)-(4.6), wherein the layer of the cured composition has a thickness of 0.1-5 mm.

(4.8) Coated article as defined under any one of items (4.1)-(4.7), wherein a primer layer is present between the substrate and the layer of the cured composition.

(4.9) Coated article as defined under item (4.8), wherein the substrate is an alloy comprising iron in an amount by weight that is higher than the amount by weight of any other chemical element and the primer layer comprises zinc, chromated zinc or a combination of these.

According to the fifth aspect of the invention, there is provided a coating preparation obtainable by mixing the first component C1 and the second component C2 of the two-component composition according to the first aspect of the invention as defined in the following.

(5.1) Coating preparation obtainable by mixing the first component C1 and the second component C2 of the two-component composition as defined under any one of items (1.1)-(1.63).

According to the sixth aspect of the invention, there is provided a use of the two-component composition according to the first aspect of the invention for coating an article as defined in the following.

(6.1) Use of the two-component composition as defined under any one of items (1.1)-(1.63) for coating an article.

Preferred embodiments of the use of the two-component composition according to the sixth aspect of the invention are described in the following.

(6.2) Use as defined under item (6.1), wherein the substrate is selected from glass, glass ceramic, glass mineral fiber mats; metals or alloys, such as aluminum, iron, steel and nonferrous metals, or surface-finished metals or alloys such as galvanized or chromed metals; coated or painted substrates, such as powder-coated metals or alloys or painted sheet metal; plastics, such as polyvinyl chloride (rigid and flexible PVC), acrylonitrile-butadiene-styrene copolymers (ABS), polycarbonate (PC), polyamide (PA), poly(methyl methacrylate) (PMMA), polyester, epoxy resins, especially epoxy-based thermosets, polyurethanes (PUR), polyoxymethylene (POM), polyolefins (PO), polyethylene (PE) or polypropylene (PP), polystyrene (PS), ethylene/propylene copolymers (EPM) or ethylene/propylene/diene terpolymers (EPDM), where the plastics may preferably have been surface-treated by means of plasma, corona or flames; fiber-reinforced plastics, such as carbon fiber-reinforced plastics (CFP), glass fiber-reinforced plastics (GFP) or sheet molding compounds (SMC); wood, wood-based materials bonded with resins, for example phenolic, melamine or epoxy resins, resin-textile composites or further polymer composites; or concrete, mortar, brick, gypsum or natural stone such as granite, limestone, sandstone or marble.

(6.3) Use as defined under item (6.1) or (6.2), wherein the substrate is a metal substrate.

(6.4) Use as defined under item (6.3), wherein the substrate is an alloy comprising iron in an amount by weight that is higher than the amount by weight of any other chemical element.

(6.5) Use as defined under item (6.4), wherein the substrate is steel.

According to the seventh aspect of the invention, there is provided a polyolefin which is useful as polyolefin (a) in the two-component composition according to the first aspect of the invention. The polyolefin is as defined in the following.

(7.1) Polyolefin having formula (I), (II), (III) or (IV),

HO-cyclhexyl-[—CH₂—C(CH₃)₂]ₙ₁-Lₘ-[—C(CH₃)₂−CH₂]ₙ₂-cyclohexyl-OH (I)

HO-cyclhexyl-[—CH₂—C(CH₃)₂]ₙ₁-Lₘ-[—CH₂—C(CH₃)₂]ₙ₂-cyclohexyl-OH (II)

HO-cyclhexyl-[—C(CH₃)₂—CH₂]ₙ₁-Lₘ-[—CH₂—C(CH₃)₂]ₙ₂-cyclohexyl-OH (III)

HO-cyclhexyl-Xₙ₁-Lₘ-Xₙ₂-cyclohexyl-OH (IV)

wherein

each X independently represents a repeating unit of formula #1-[—C(CH₃)₂—CH₂]-#2 wherein #1 and #2 represent the positions at which the repeating unit forms a bond to an adjacent moiety and wherein a bond between two adjacent repeating units is formed such that positions #1 and #1, #1 and #2, #2 and #1 or #2 and #2 of the adjacent repeating units are bonded to each other,

L is a hydrocarbon group having 5 or more carbon atoms,

m is 0 or 1,

each of n1 and n2 is a numerical value of 1 or more and

n1+n2 is in the range of from 5-200, preferably 10-150, more preferably 15-100, even more preferably 20-50, most preferably 25-40.

Preferred embodiments of the polyolefin having formula (I) are described in the following.

(7.2) Polyolefin as defined under item (7.1), wherein n is in the range of 10-150.

(7.3) Polyolefin as defined under item (7.1), wherein n is in the range of 15-100.

(7.4) Polyolefin as defined under item (7.1), wherein n is in the range of 20-50.

(7.5) Polyolefin as defined under item (7.1), wherein n is in the range of 25-40.

(7.6) Two-component composition as defined under any one of items (7.1)-(7.5), wherein L is a group having 6-20 carbon atoms and comprising an aromatic moiety.

(7.7) Two-component composition as defined under any one of items (7.1)-(7.5), wherein L is a group having 6-14 carbon atoms.

(7.8) Two-component composition as defined under any one of items (7.1)-(7.5), wherein L is a group having 6-12 carbon atoms.

(7.9) Two-component composition as defined under any one of items (7.1)-(7.5), wherein L is a group represented by the following formula,

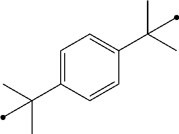

wherein the positions marked with indicate the position to which the repeating units of the polymer backbone are attached.

(7.10) Polyolefin as defined under any one of items (7.1)-(7.9), wherein the polyolefin is represented by the following formula

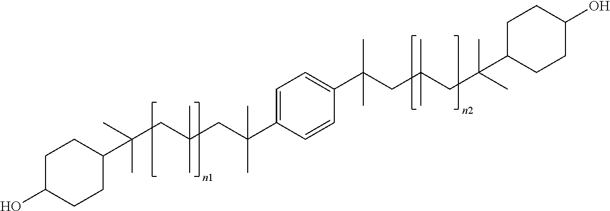

wherein each of n1 and n2 is a numerical value of 1 or more and

n1+n2 is in the range of from 5-200, preferably 10-150, more preferably 15-100, even more preferably 20-50, most preferably 25-40.

The two-component composition according to the first aspect of the present invention comprises a compound having isocyanate groups in its molecular structure, namely compound (b1) and/or compound (b2) as defined hereinabove. It is known to the skilled person that isocyanate groups have the tendency to form adducts and/or reaction products of addition reactions which can release the isocyanate groups again at elevated temperatures, i.e. the respective adduct or addition reaction product is decomposed and the reaction of forming said adduct or addition reaction product is reversed. These adducts and/or addition reaction products are also referred to as blocked isocyanates or masked isocyanates. Blocked isocyanates can for instance contain allophanate groups, uretdione groups, isocyanurate groups. It is also known in the art that blocked isocyanate groups can also be formed by reacting isocyanate groups with agents such as diethyl malonate, dimethyl pyrazole, methylethyl ketoxime and ε-caprolactame. Within the framework of the present invention, it is possible to use compounds having such blocked isocyanate groups in order to partially or completely substitute compounds having (unblocked) isocyanate groups. In other words, compounds having blocked isocyanate groups can be used as equivalents to compound (b1) as defined hereinabove and, therefore, compounds having 2 or more blocked isocyanate groups represent a polyisocyanate having 2 or more isocyanate groups in the sense of the claims of the present application. Likewise, it is possible to use an equivalent to compound (b2) in which some or all of the isocyanate groups have been blocked as a substitute of compound (b2). Therefore, a reaction product having all features of compound (b2), except that the isocyanate groups are blocked, nevertheless represents a compound (b2) in the sense of the claims of the present application.

The two-component composition can comprise further constituents as known to the person skilled in the art from two-component polyurethane chemistry. These may be present in one of component C1 and component C2 or in both components. As component C2 comprises components having reactive isocyanate groups, it is preferred that these further constituents are present in composition C2 in order to avoid any incompatibility and/or premature and undesired reaction of said further constituents with the reactive isocyanate groups.

Suitable further constituents are fillers, solvents, plasticizers, adhesion promoters, stabilizers, rheology aids, desiccants such as zeolites in particular, stabilizers against oxidation, heat, light or UV radiation, flame-retardant substances, or surface-active substances such as wetting agents or defoamers in particular.

The composition preferably comprises at least one filler, for instance an inorganic or organic filler, such as natural, ground or precipitated calcium carbonates, optionally coated with fatty acids, especially stearic acid, baryte (heavy spar), talcs, quartz flours, quartz sand, dolomites, wollastonites, kaolins, calcined kaolins, mica (potassium aluminum silicate), molecular sieves, aluminum oxides, aluminum hydroxides, magnesium hydroxide, silicas including finely divided silicas from pyrolysis processes, graphite, carbon black, metal powders such as aluminum, copper, iron, silver or steel, PVC powder and/or hollow spheres.

The addition of fillers is advantageous in that it affects the rheological properties and it is possible to increase the strength of the cured polyurethane composition. Preferably, the polyurethane composition comprises at least one filler selected from the group consisting of calcium carbonate, especially in ground form, kaolin, baryte, talc, quartz flour, dolomite, wollastonite, kaolin, calcined kaolin, mica and carbon black.

The use of carbon black especially also increases the thixotropy or creep resistance of the composition, which is preferable. A particularly suitable thixotropic agent is industrially produced carbon black.

The proportion of the fillers in the two-component composition is preferably in the range of from 5% to 60% by weight, more preferably in the range from 5% to 50% by weight and especially in the range from 10% to 40% by weight of the total weight of the two-component composition. The proportion of carbon black is preferably in the range from 1% to 15% by weight, especially in the range from 5% to 15% by weight, relative to the total weight of components C1 and C2.

The two-component composition may further comprise plasticizers. The two-component composition preferably comprises less than 5% by weight, more preferably less than 1% by weight, especially less than 0.1% by weight, of plasticizers, relative to the total weight of components C1 and C2.

“Molecular weight” is understood in the present document to mean the molar mass (in grams per mole) of a molecule. “Average molecular weight” is understood to mean the number-average Mn of an oligomeric or polymeric mixture of molecules, unless otherwise indicated. The number-averaged molecular weight Mn as well as the weight-averaged molecular weight Mw are determined using a gel permeation chromatography method, for instance using the conditions specified in example 1.

“Average number of functional groups” is the total number of functional groups, i.e. hydroxyl groups, primary amine groups and secondary amine groups, per polymer molecule, averaged over all the polymer molecules. If, for example, 50% of all polymer molecules contain two hydroxyl groups and the other 50% contain three, the result is an average number of functional groups of 2.5. The average number of functional groups can especially be determined by calculation from the hydroxyl number (according to ASTM 1899-08) and the amine number (according to ASTM 1899-08) and the molecular weight Mn determined by GPC. The content of isocyanate groups can be determined according to ASTM D 5155.

“Steel” is understood in the present document to refer to any alloy comprising (i) iron in an amount by weight that is higher than the amount by weight of any other chemical element and (ii) carbon in an amount of 2% by weight or less. This definition is in accordance with DIN EN 10020.

The term “primer” is understood as a preparatory coating put on materials before applying the composition resulting in the intended coating. Priming usually ensures better adhesion of the coating to the surface, increases coating durability, and can provide additional protection for the material being coating. A primer typically consists of a synthetic resin, solvent and additive agent. In a primer designed for metal the additive agent can be zinc powder and the synthetic resin can be an epoxy resin. Zinc as the active agent can be contained in a primer composition in amounts which result in a film coating having a content of up to 85% by weight of metallic zinc powder.

### EXAMPLES

### Example 1: Preparation of di(cyclohexanol-terminated) polyisobutylene

### Step a): Preparation of polyisobutylene (PIB-BV)

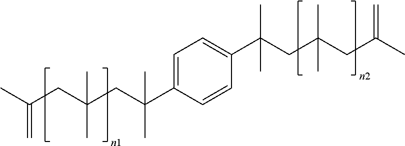

A four-necked 2 litre round-bottom flask equipped with dropping funnel with pressure compensator and dry ice-cooled condenser, nitrogen feed, magnetic stirrer and a tube connector to a second four-necked 2 litre round-bottom flask was charged with 500 ml n-hexane and 500 ml dichloromethane which was cooled to 76° C. and flushed with nitrogen.

500 ml isobutylene were condensed into the dropping funnel and the condensed amount of isobutylene was discharged into the round-bottom flask. A spatula-tip of phenanthroline was added as indicator to the solution. The solution was titrated using 25 ml of a solution of n-butyllithium (1.6 M in hexane) until colour changed. A brownish colouring was observed after 15 ml of the solution of n-butyllithium had been added.

The cooling bath was removed and flask was warmed in a water bath. Isobutylene and the solvent mixture distilled to the second round-bottom flask which was cooled in a dry ice/acetone bath. The second round-bottom flask was equipped with mechanical stirrer, stirring blade, dry ice-cooled condenser and thermometer.

At a temperature of −77° C. were added 3.75 g of phenyltriethoxysilane and 39 g of 1,4-dicumylchloride (1,4-bis(2-chloro-2-propyl)benzene). Subsequently, 5.75 ml of titanium tetrachloride were added by syringe. The internal temperature was allowed to rise to a maximum of −40° C. within 5 minutes and dropped rapidly in about 10 minutes to −74° C. The reaction mixture turned brownish and was stirred vigorously for 2 hours at a temperature of −70 to −76° C. Then, the reaction was stopped by addition of 250 ml of isopropanol, was allowed to warm to room temperature and was degassed.

The content of the flask was transferred to a separatory funnel, diluted with 500 ml of hexane and then washed with 500 ml of methanol and three times with 500 ml of water. The organic phase was dried over sodium sulfate, filtrated using a fine folded filter and the solvent was evaporated at 180° C. at a reduced pressure of 5 mbar.

Yield: 330 g clear colourless product

GPC analysis (calibrated using polystyrene standards, ERC-RI-101 detector, tetrahydrofurane as eluent, flow rate 1000 ml/minute) gave the following results.

Mn=2500 g/mol

Mw=3500 g/mol

PDI=1.4

¹H-FT-NMR (500 MHz, 15 scans, CD₂Cl₂):

Polymer: 1.43 ppm, s (CH₂); 1.12 ppm, s (CH₃)

Aromatic starter in polymer: 7.26 ppm, 4H, s

Terminal functionalization: 4.64 ppm, 1H, s; 4.85 ppm, 1H, s; 5.16 ppm, 1H, s.

Composition according to NMR analysis: 85% alpha-olefin (CH₂C(CH₃)═CH₂), 15% beta-olefin (CH═C(CH₃)CH₃), 0% terminal chlorine (CH₂C(CH₃)₂Cl).

### Step b): Preparation of di(phenol-terminated) polyisobutylene (PIB bis-phenol)

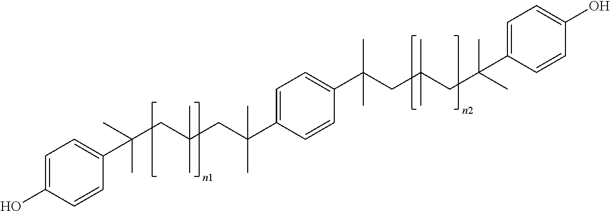

60 g of phenol were charged into a four-necked four-necked 2 litre round-bottom flask equipped with a stirrer and nitrogen feed. The phenol was dissolved under nitrogen in 60 g of toluene. 6.5 g of a solution of BF₃-phenolate (4 mol-%) were added at room temperature. The solution turned dark-red. 320 g of PIB-BV in 200 g of hexane were added dropwise over 30 minutes at 18-22° C. The reaction mixture was cooled using cold water and stirred over night at a temperature of 22-23° C. After 18 hours, the reaction was stopped by addition of 200 ml of methanol. The reaction mixture was transferred to a separatory funnel, further 200 ml of methanol and some water were added and the mixture was extracted. The hexane phase was washed three times with 200 ml of a mixture of methanol and water (10/1). The product phase was dried with sodium sulfate, filtrated and the solvent was evaporated from the filtrate at a temperature of 140° C. at a reduced pressure of 5 mbar.

Yield: 320 g of yellow viscous product

¹H-FT-NMR (500 MHz, 16 scans, CD2Cl2):

Phenol functionalization: 7.22 ppm, 2H, d; 6.74 ppm, 2H, d.

### Step c): Hydrogenation of di(phenol-terminated) polyisobutylene (PIB bis-phenol)

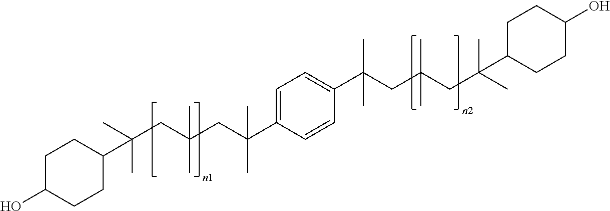

840 g of PIB bis-phenol and 400 g n-heptane were charged into a 3.5 litre stirring vessel. 0.5 g NaH was added as a solution in paraffin oil (60% NaH) and the mixture was heated under slightly reduced pressure, i.e. the pressure was reduced such that the heptane did not boil. 200 g of Raney-Nickel was washed four times with 200 ml of ethanol and added to the reaction mixture. Hydrogen gas at a pressure of 150 bar was fed to saturation into the stirring vessel at 100° C. for two hours and subsequently at a pressure of 150 bar at 150° C. for ten hours. Then the reaction mixture was degassed and flushed with nitrogen. The Raney-Nickel was filtered off and deactivated with acid. The heptane solvent was evaporated from the filtrate at a temperature of 140° C. at a reduced pressure of 5 mbar.

Yield: 820 g of viscous, light-coloured and slightly turbid product

OH value: 32 mg KOH/g

¹H-FT-NMR (500 MHz, 16 scans, CD₂Cl₂):

No phenol functionalization detectable

Aromatic starter in polymer (not hydrogenated): 7.26 ppm, 4H, s

Terminal group: 3.46 ppm, m (trans-CH-OH, 65%); 3.97 ppm, m (cis-CH-OH, 35%)

1. A two-component composition comprising, in a spatially separated arrangement:
(C1) a first component comprising:
(a) a polyolefin having a polymer backbone consisting of (a-i) repeating units derived from an olefinically unsaturated monomer having 4 carbon atoms and, optionally, (a-ii) a hydrocarbon group L having 5-20 carbon atoms in a non-terminal position of said polymer backbone, wherein said polymer backbone has functional groups selected from hydroxyl groups and amine groups at its chain ends; and
(C2) a second component comprising a preparation comprising:
(b1) a polyisocyanate having 2 or more isocyanate groups and/or
(b2) a reaction product having isocyanate groups obtained by reacting said polyisocyanate having 2 or more isocyanate groups (b1) and (b2a) a polyolefin having a polymer backbone consisting of (b2a-i) repeating units derived from an olefinically unsaturated monomer having 4 carbon atoms and, optionally, (b2a-ii) a hydrocarbon group having 5-20 carbon atoms in a non-terminal position of said polymer backbone, wherein said polymer chain has functional groups selected from hydroxyl groups and amine groups at its chain ends.

2. The two-component composition as defined in claim 1, wherein said olefinically unsaturated monomer having 4 carbon atoms forming polyolefin (a) and/or polyolefin (b2a) has 1 olefinic double bond or 2 olefinic double bonds.

3. The two-component composition as defined in claim 1, wherein the functional groups of the polyolefin (a) and/or polyolefin (b2a) are primary amine groups NH₂ or secondary amine groups NHR, wherein R represents a hydrocarbon group having 1 to 12 carbon atoms.

4. The two-component composition as defined in claim 1, wherein the functional groups of the polyolefin (a) and/or polyolefin (b2a) are hydroxyl groups.

5. The two-component composition as defined in claim 1, wherein the polyolefin (a) and/or polyolefin (b2a) is a polyolefin represented by formula (I), (II), (III), (IV) or a combination of these polyolefins,
HO-cyclhexyl-[—CH₂—C(CH₃)₂]ₙ₁-Lₘ-[—C(CH₃)₂−CH₂]ₙ₂-cyclohexyl-OH (I)
HO-cyclhexyl-[—CH₂—C(CH₃)₂]ₙ₁-Lₘ-[—CH₂—C(CH₃)₂]ₙ₂-cyclohexyl-OH (II)
HO-cyclhexyl-[—C(CH₃)₂—CH₂]ₙ₁-Lₘ-[—CH₂—C(CH₃)₂]ₙ₂-cyclohexyl-OH (III)
HO-cyclhexyl-Xₙ₁-Lₘ-Xₙ₂-cyclohexyl-OH (IV)
wherein
each X independently represents a repeating unit of formula #1-[—C(CH₃)₂—CH₂]-#2 wherein #1 and #2 represent the positions at which the repeating unit forms a bond to an adjacent moiety and wherein a bond between two adjacent repeating units is formed such that positions #1 and #1, #1 and #2, #2 and #1 or #2 and #2 of the adjacent repeating units are bonded to each other,
L is a hydrocarbon group having 5 or more carbon atoms,
m is 0 or 1,
each of n1 and n2 is a numerical value of 1 or more and
n1+n2 is in the range of from 5-200.

6. The two-component composition as defined in claim 1, wherein the molecular weight of the polyolefin (a) and/or polyolefin (b2a) is in the range of from 200-10000 g/mol.

7. The two-component composition as defined in claim 1, wherein the polyisocyanate having 2 or more isocyanate groups (b1) is a diisocyanate.

8. The two-component composition as defined in claim 1, wherein said polyolefin (b2a) is different from polyolefin (a).

9. The two-component composition as defined in claim 1, wherein the preparation (b) is obtained by mixing said polyisocyanate having 2 or more isocyanate groups (b1) and said polyolefin (b2a) in such amounts that the molar ratio of the isocyanate groups present in said polyisocyanate having 2 or more isocyanate groups (b1) and the functional groups in said polyolefin (b2a) is in the range of from 2:1 to 10:1.

10. The two-component composition as defined in claim 1, wherein said polyolefin (a), said preparation (b) and, if present, any reactive diluent are present in amounts such that the ratio of the molar amount of the isocyanate groups present in said preparation (b) and the molar amount of functional groups present in said polyolefin (a) and said reactive diluent is in the range of from 1:1 to 1.15:1.

11. A coating preparation obtained by mixing the first component C1 and the second component C2 of the two-component composition as defined in claim 1.

12. A method of preparing a coating layer from the two-component composition as defined in claim 1 comprising the steps of:
(i) mixing the first component C1 and the second component C2 of the two-component composition as defined in claim 1,
(ii) applying the mixed components C1 and C2 to a substrate such that a layer is formed, and
(iii) allowing the mixed components C1 and C2 to cure.

13. A cured composition obtained by: (i) mixing the first component C1 and the second component C2 of the two-component composition as defined in claim 1 and (ii) allowing the mixed components C1 and C2 to cure.

14. A coated article comprising a substrate and a layer of the cured composition as defined under claim 13, wherein the substrate is selected from glass, glass ceramic, glass mineral fiber mats; metals or alloys, such as aluminum, iron, steel and nonferrous metals, or surface-finished metals or alloys such as galvanized or chromed metals; coated or painted substrates, such as powder-coated metals or alloys or painted sheet metal; plastics, such as polyvinyl chloride (rigid and flexible PVC), acrylonitrile-butadiene-styrene copolymers (ABS), polycarbonate (PC), polyamide (PA), poly(methyl methacrylate) (PMMA), polyester, epoxy resins, especially epoxy-based thermosets, polyurethanes (PUR), polyoxymethylene (POM), polyolefins (PO), polyethylene (PE) or polypropylene (PP), polystyrene (PS), ethylene/propylene copolymers (EPM) or ethylene/propylene/diene terpolymers (EPDM); fiber-reinforced plastics, such as carbon fiber-reinforced plastics (CFP), glass fiber-reinforced plastics (GFP) or sheet molding compounds (SMC); wood, wood-based materials bonded with resins, for example phenolic, melamine or epoxy resins, resin-textile composites or further polymer composites; or concrete, mortar, brick, gypsum or natural stone such as granite, limestone, sandstone or marble.

15. A method of utilizing the coating preparation as defined under claim 11 for coating an article.

16. (canceled)

17. The two-component composition as defined in claim 2, wherein the olefinically unsaturated monomer is preferably selected from the group consisting of: butadiene, n-butene, 2-butene, isobutene, and mixtures thereof.

18. The two-component composition as defined in claim 3, wherein R represents a linear or branched alkyl group having 1-6 carbon atoms.

19. The two-component composition as defined in claim 3, wherein R represents a linear or branched alkyl group having 1-4 carbon atoms.

20. The two-component composition as defined in claim 5, wherein n1+n2 is in the range of from 10-150.

21. The two-component composition as defined in claim 5, wherein n1+n2 is in the range of from 15-100.

22. The two-component composition as defined in claim 5, wherein n1+n2 is in the range of from 20-50.

23. The two-component composition as defined in claim 5, wherein n1+n2 is in the range of from 25-40.

24. The two-component composition as defined in claim 5, wherein the polyolefin (a) and/or polyolefin (b2a) preferably is a polyolefin represented the following formula: 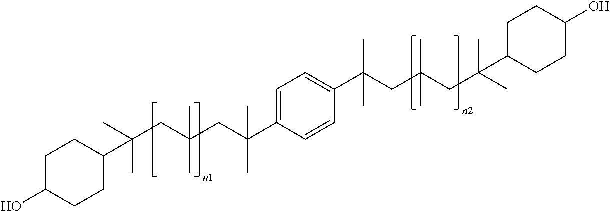
wherein each of n1 and n2 is a numerical value of 1 or more and n1+n2 is in the range of from 5-200.

25. The two-component composition as defined in claim 24, wherein n1+n2 is in the range of from 10-150.

26. The two-component composition as defined in claim 24, wherein n1+n2 is in the range of from 15-100.

27. The two-component composition as defined in claim 24, wherein n1+n2 is in the range of from 20-50.

28. The two-component composition as defined in claim 24, wherein n1+n2 is in the range of from 25-40.

29. The two-component composition as defined in claim 6, wherein the molecular weight of the polyolefin (a) and/or polyolefin (b2a) is in the range of from 500-5000 g/mol.

30. The two-component composition as defined in claim 6, wherein the molecular weight of the polyolefin (a) and/or polyolefin (b2a) is in the range of from 1000-2500 g/mol.

31. The two-component composition as defined in claim 7, wherein the diisocyanate is selected from the group consisting of: tolylene 2,4-diisocyanate, tolylene 2,6-diisocyanate, a mixture of these isomers (TDI), diphenylmethane 4,4′-diisocyanate, diphenylmethane 2,4′-diisocyanate or diphenylmethane 2,2′-diisocyanate, a mixture of these isomers (MDI), phenylene 1,3-diisocyanate or phenylene 1,4-diisocyanate, 2,3,5,6-tetramethyl-1,4-diisocyanatobenzene, naphthalene 1,5-diisocyanate (NDI), 3,3′-dimethyl-4,4′-diisocyanatodiphenyl (TODI), dianisidine diisocyanate (DADI), tetramethylene 1,4-diisocyanate, 2-methylpentamethylene 1,5-diisocyanate, hexamethylene 1,6-diisocyanate (HDI), 2,2,4-trimethylhexamethylene 1,6-diisocyanate, 2,4,4-trimethylhexamethylene 1,6-diisocyanate, a mixture of these isomers (TMDI), decamethylene 1,10-diisocyanate, dodecamethylene 1,12-diisocyanate, cyclohexane 1,3-diisocyanate, cyclohexane 1,4-diisocyanate, 1-methyl-2,4-diisocyanatocyclohexane, 1-methyl-2,6-diisocyanatocyclohexane, a mixture of these isomers (HTDI or H6TDI), 1-isocyanato-3,3,5-trimethyl-5-isocyanatomethylcyclohexane (isophorone diisocyanate or IPDI), perhydro(diphenylmethane) 2,4′-diisocyanate, perhydro(diphenylmethane) 4,4′-diisocyanate (HMDI or H12MDI), 1,4-diisocyanato-2,2,6-trimethylcyclohexane (TMCDI), 1,3-bis(isocyanatomethyl)cyclohexane, 1,4-bis(isocyanatomethyl)cyclohexane, m-xylylene diisocyanate (m-XDI), p-xylylene diisocyanate (p-XDI), m-tetramethylxylylene 1,3-diisocyanate, m-tetramethylxylylene 1,4-diisocyanate, (m-TMXDI), p-tetramethylxylylene 1,3-diisocyanate, p-tetramethylxylylene 1,4-diisocyanate (p-TMXDI), bis(1-isocyanato-1-methylethyl)naphthalene, and mixtures thereof.

32. The two-component composition as defined in claim 9, wherein the molar ratio is in the range of from 2.5:1 to 8:1.

33. The two-component composition as defined in claim 9, wherein the molar ratio is in the range of from 3:1 to 6:1.

34. The two-component composition as defined in claim 9, wherein the molar ratio is in the range of from 3.5:1 to 5:1.

35. The two-component composition as defined in claim 10, wherein the ratio of the molar amount of the isocyanate groups present in said preparation (b) and the molar amount of functional groups present in said polyolefin (a) and said reactive diluent is in the range of from 1.01:1 to 1.12:1.

36. The two-component composition as defined in claim 10, wherein the ratio of the molar amount of the isocyanate groups present in said preparation (b) and the molar amount of functional groups present in said polyolefin (a) and said reactive diluent is in the range of from 1.02:1 to 1.10:1.

37. The coated article as defined in claim 14, wherein the plastics have been surface-treated by means of plasma, corona, or flames.

38. The coated article as defined in claim 14, wherein the substrate is a metal substrate.

39. The coated article as defined in claim 14, wherein the substrate is an alloy comprising iron in an amount by weight that is higher than the amount by weight of any other chemical element.

40. The coated article as defined in claim 14, wherein the substrate is steel.
